(19) United States
(12) Patent Application Publication
(10) Pub. No.: US 2023/0194104 A1
(43) Pub. Date: Jun. 22, 2023

(54) ARRANGEMENT WITH TWO OR MORE LAYERED NATURAL STONE SLABS

(71) Applicant: Kuse KOLJA, München (DE)

(72) Inventor: Kuse KOLJA, München (DE)

(21) Appl. No.: 16/963,188

(22) PCT Filed: Dec. 4, 2018
(86) PCT No.: PCT/EP2018/000543

§ 371 Date: Jul. 10, 2021

(30) Foreign Application Priority Data
Dec. 4, 2017 (DE) 20 2017 006 231.3

(51) Int. Cl. F24C 15/10; H05B 6/06

(52) U.S. Cl. CPC F24C 15/102; H05B 6/062; H05B 6/1254

(57) ABSTRACT

The invention relates to the asymmetric structure, in terms of the layer structure, of two or more stone slabs—generally two—wherein the load-bearing bottom slab is designed to be thicker than the top slab which is to be stabilized and which forms the surface of an induction hob assembly. The thickness or stiffness of the bottom stone slab is designed in conjunction with an adequately dimensioned tension-resistant fibre layer such that the tensile stresses in the top slab resulting from the expansion of the top slab during cooking, especially on the surface, because of the bi-metal effect, that is to say from dishing up of the slab, are not exceeded to avoid any hairline crack formation. To this end, the cross-section and/or the stiffness of the bottom slab is to be designed to be so thick in the counter-stabilizing edge regions that the expansion forces of the top stone slab in the cooking zone are adequately compensated for by the compression zone beneath the tension-resistant fibre layer such that the maximum permissible tensile stress on the surface of the top stone slab, which makes up the hob, is not exceeded even if the maximum permissible cooking temperature is reached. In order to prevent deflection or dishing of the entire assembly as a result of the bi-metal effect, a sufficiently porous stone material is selected for the surface which is compressible in volume and/or preferably less resistant to compression than the bottom stabilizing slab, which provides the counter-pressure. To receive the induction coil, the slab assembly is milled out from below to close to the surface, so that the distance between the induction coil and the pan is as small as possible. The milled-out portion is designed to be domed to enhance mechanical stability against pressure and impact from above. Additional fibre reinforcement can be applied here to provide greater support. Circulating air layers are used beneath and, where necessary, on top of the stone surface to keep the surface temperatures on the hob and on the underside of the cooking zone as low as possible. These measures together serve the purpose of preventing the usual hairline cracking on the surface of the complete assembly.

The present invention relates to a development to realize cooking on stone slabs such as natural stone, artificial stone such as concrete or other mineral materials such as e.g. to realize glass-containing material or ceramics, hereinafter referred to collectively as “stone slabs”. According to the prior art, induction coils are arranged below the surface of stone slabs, through which a relatively high-frequency alternating current flows, which transmits electromagnetic energy into a magnetizable metal pot—usually consisting of ferromagnetic material—which is located above the alternating field generated by the alternating current, whereby the magnetizable dipoles of the ferromagnetic pot material, the so-called elementary magnets or Weiß's districts, of the magnetizable metal of the pot are reversed according to a hysteresis and the polarity reversal of the elementary dipoles depending on the pot material is superimposed by eddy currents, whereby approx. ⅓ of the induction power is converted by the polarity reversal of the elementary districts into frictional heat in the pot material and the remaining ⅔ of the energy is induced in the form of directed eddy currents in the pot surface, which is a circular alternating electric current in the pot material, generating heat when the electrical resistance (ohmic resistance) of the pot material is sufficiently large, or is greater than the resistance of the induction coil, which usually consists of copper wire and thus has a significantly lower specific resistance than ferromagnetic pot material. The pot becomes so hot due to the two mechanisms of eddy currents and the polarity reversal of the elementary magnets so that, depending on the nature of the pot, temperatures in the pot bottom of over 400° C. can arise. The ratio of the two heat generation mechanisms depends on the pot thickness and the exact composition of the pot material. In extreme cases, the energy is generated almost exclusively by eddy currents.

The difficulties of using natural stone as a surface for induction cookers were partially solved by previous developments by mechanically protecting the stone against tearing breakage, as was already written in EP 94 10 7945.1 in 1994. On the one hand, the extremely high temperatures that can arise during inductive cooking in the bottom of the pot are unsolved, because contrary to popular belief, inductive cooking is not so-called “cold” cooking; on the contrary, pots and pans on the bottom of the pan reach that same or, under certain circumstances, even higher temperatures than on conventional hobs with heat transfer due to direct material contact of a pot to be heated with a heating field.

The main difficulty, however, is preventing the stone slab from forming hairline cracks on the hob surface. The complete tearing or breaking through of the stone slabs, which is caused by the punctual heating of the stone slab by the heating pot, was solved by using carbon fibers, as described in EP 94 10 7945.1, which makes it possible to control the centric expansion forces that arise from the center of the pot and which at some point become so large as the temperature rises that the stone can only be prepared for these tensile forces by suitable stabilization measures with a full-surface carbon reinforcement layer in order to prevent it from completely failing due to tearing. Other measures, such as the introduction of threaded rods, are completely inadequate to prevent the stone plate from being torn through, whereby the tearing being forced through the punctual heating up of the pot and the associated expansion of the stone material respectively occurring pressure which thereby is being forced into the cooking zone, which causes an impermissible tensile load in the edge area because the material in this area remains cold and does not expand like the material in the cooking zone. The exceeding of the tensile load in the edge area caused by this temperature difference is the initial zone for tearing through the entire stone slab. The measure of a large or full-surface coating of the stone slabs with carbon fibers or the introduction of a middle layer of carbon between two stone slabs prevents the stone slab from tearing and the initial crack initiation, but it does not necessarily prevent the formation of hairline cracks on the surface of the upper stone slab, for which the measures described in this application serve.

From today's point of view, the most suitable measure of basic stabilization against tearing through of the stone slabs starting from the edge area is still at best realized, as described in EP 94 10 7945.1, by a flat bonding of carbon fiber fabric between two stone slabs, which basically prevents the stone from ripping and in principle keeps it together despite the resulting expansion forces, whereby two equally strong granite slabs are reinforced with the help of a carbon fiber fabric that is laid out over the entire surface or over a large area in the middle layer of the overall arrangement, which is designed strong enough to prevent the granite slab from being torn through. In EP 94 10 7945.1, the induction coil structure is completely filled with a casting compound in a cavity milled for it below the stone slab. In contrast, in the present invention, the milling is left as open as possible so that heat can be dissipated by forced air circulation.

A major problem is—as has been shown in further experiments in the implementation of EP 94 10 7945.1—that the cavity potting agents in the area of the cooking zone become so hot that they cannot withstand the high temperatures caused by cooking or roasting, arising even below the stone slabs and easily exceed the 200° C. limit and can reach 300° C. over longer cooking times. For this reason, the cooking zone must be air-cooled, and in this case also be stabilized differently against impact or force from above, since the mechanically stabilizing effect of the potting compound is eliminated. The recess in the plate below the cooking zone, which must necessarily interrupt the continuously stabilizing carbon layer, which also does not withstand temperatures of well over 200° C., must now be protected directly below the cooking zone against breaking and impact forces from above. For this reason, two measures are taken: firstly, an arch structure in the form of a concave underside of the stone slab is created, which realizes the necessary mechanical stabilization by pressure from above. This constructive measure is necessary in particular because the distance between the induction coil and the pot should be as small as possible, for which the stone layer thickness in this area must be as thin as possible on the one hand and on the other hand the stone layer in the hob area must remain sufficiently stable.

In addition or as an alternative to this, in order to achieve the necessary impact resistance, a suitable fabric layer can be introduced, which is attached to the underside of the stone with a special adhesive that can withstand temperatures up to at least 400° C., such as Example of high-temperature-resistant lacquers, which on the one hand adhere well to the porous stone material and on the other hand enclose the fabric fibers in a force-fitting manner. Due to the high temperatures in this area, the usual CFRP composites—which are used, for example, to bond the two stone slabs with the carbon layer in between—are not yet suitable.

Ideally, however, carbon fibers are used for all stabilization measures, both for the reinforcement of the doubled stone slabs and for the stabilization of the stone below the cooking zone, because on the one hand they are able to absorb the highest tensile forces, while on the other hand provide a low tensile elongation and at the same time a lower coefficient of thermal expansion than Natural stone, as well as generally a lower coefficient of thermal expansion than that of all other commercially available fiber types, which ultimately means a high rigidity of the overall construction, even if the stressful temperature increase of the upper stone layer comes into play. This combination of properties makes the carbon fiber ideal or even uniquely suitable for this type of stabilization application. Glass fibers, for example, have a higher coefficient of thermal expansion than natural stone. The temperature-related hairline crack-free expansion of the stone is only possible without the upper stone layer bulging upwards, if a stone is selected that finds the necessary expansion space in its own crystalline-porous structure, which is a necessary technical requirement for this invention to be successful. As an alternative, glass fibers or stone fibers can also be used, because carbon fiber fabrics have a difficulty in this context, because conventional 0°/90° fabric structures absorb inductive energy through eddy currents that can flow in an electrically closed fiber fabric, because the carbon fiber is electrically conductive and has a very high ohmic resistance. This means that the usual carbon fabrics in the area of the stone slab directly below the cooking zone cannot be used for stabilization, since the induction energy of the coil would be dampened on the one hand by a carbon fiber braid and therefore can only act poorly through this carbon layer and this braid itself is consequently strongly heated up, which is undesirable since the heat is to be generated in the bottom of the pot and not in the fiber layer, which would also lead to undesired heating of the stone layer and the resins of the CFRP structure which are not designed for such temperatures.

This problem is solved by interrupting or milling out the carbon layer used to stabilize the stone in the area of the cooking zone, after which either fibers other than carbon fibers are used in the area of the cooking zone, or alternatively only glass fibers or the somewhat stiffer basalt fiber (Stone fibers) are used because they have a similarly small coefficient of thermal expansion as stone. Since temperatures are reached in this area that do not allow conventional CFRP or GFRP composites made of epoxy resins, the stabilizing fiber layer in this area must be attached with temperature-stable adhesives, which do not have the mechanical stability like epoxy resins, but are sufficiently stable at this point and withstand a permanent temperature of at least 300° C.

In EP 94 10 7945.1, however, there is in particular no teaching on the question of the level in which the carbon layer or fiber layer should be applied between the stone slabs, except, as suggested in the drawings of EP 94 10 7945.1, in a symmetrical arrangement in which the two stone layers separated by the carbon layer are of the same thickness or thinness. This arrangement prevents tearing of the stone slabs, but not the curvature of the overall arrangement and the associated formation of hairline cracks on the surface of the upper stone slab, since the rigidity of the upper slab of the overall arrangement must always be greater than the rigidity of the slab below the carbon layer. Although this would not be the case if a significantly stiffer stone were used on the underside, this teaching is not provided by EP 94 10 7945.1. The overall arrangement bulges so much due to the expansion forces on the surface without suitable countermeasures that the permissible tensile stress of the stone on the surface is exceeded at least to such an extent that hairline cracking is the result. The reason is the inadequate mechanical counter-stabilization in the area of milling by the potting compound, which does not withstand the high temperatures and, according to the teaching from the present application, has to give way entirely in favor of forced cooling by air and thus also the question of the ratio of the stiffnesses of the Material arrangements above and below the tensile resistant carbon layer must be posed. The question of the permissible tensile stress on the surface and sufficient counter-stabilization below the rigid carbon layer is—as further tests have shown—of crucial importance for avoiding hairline cracks on the hob surface. It has been shown that a more detailed consideration of the dimensioning of the stone layer thicknesses is necessary for the success of the overall arrangement, with a view to the formation of cracks on the surface of such arrangements and the avoidance of the crack-causing curvature of the surface due to the enormous expansion forces that occur during cooking arising on the surface of the overall arrangement, which is forced to hold together by the stiff and extremely tensile carbon layer, but does not necessarily help that the surface remains so flat that finest cracks are prevented on the surface of the upper stone layer. A technically sufficient dimensioning of the ratios of the plate thicknesses of the upper and lower stone slabs, i.e. the thickness of the stone slab above the rigid carbon layer in relation to the counter-stabilizing lower stone slab below the carbon layer, is necessary in order to prevent the overall arrangement from bending and, in particular, forming hairline cracks on the surface. The slightest hairline cracking is to be avoided 100% for optical and hygienic reasons. So that the hob surface remains so even that hairline cracks are avoided—if the pressure forces on the surface become large due to the expansion of the material during cooking and on the other hand sufficient counter-stabilization on the underside is to be ensured, even though the stone is in the coil area and thus on the the entire coil surface is milled—the bending forces over the edge zones—i.e. the areas between the milled area and the edges of the entire doubled areas of the plate—must be kept under control, which is why the lower stone layer—at least in the area of these edge zones—must have a corresponding cross-section, which is able to generate the appropriate back pressure in order to avoid excessive curvature of the surface of the overall arrangement.

The main innovation in the structure proposed here is the idea of achieving this balance of forces by dimensioning the thickness of the stone layers below and above the carbon layer in such a way that the plate has virtually no noticeable curvature on the surface, at least none of those that would result in exceeding the permissible tensile stress of the stone material on the surface. For this reason, the lower layer of stone should be stronger—generally thicker—than the upper layer of stone. The greater the quotient from the upper to lower stone layer thickness, the less the deflection or the stiffer the overall arrangement, which avoids the formation of hairline cracks on the surface. As additional help, a suitable stone with a sufficiently high porosity can be volume-compressed under pressure within certain limits, namely within the limits of its natural crystalline porosity. It is thus de facto possible to suppress the so-called bimetal effect and, through a suitable ratio of lower to upper stone layer thickness, the curvature of the surface, as well as a buckling of the surface in the relatively thin cooking zone—even with intensive cooking—can be avoided or kept within a range that does not exceed the tensile strength limit of the stone surface in order to completely prevent hairline cracking. The limits of this resilience of different stones—for the determination of suitable types of stone—and the optimal or sufficient ratio of the stone layer thicknesses above and below the reinforcing carbon layer—depending on the desired geometries with regard to arrangement, number, density and size of more or less closely spaced cooking zones—can nowadays be easily implemented with modern computer-based simulation tools based on finite element programs—FEM simulation. It is crucial that the ratio of the expanding stone mass on the surface in the area of the cooking zone—or the cross section of the stone material in the area of the cooking zone above the stabilizing carbon layer—through sufficient stone mass below the carbon layer—or the cross section of the material in the peripheral areas—in a ratio that does not allow the permissible tensile stress on the stone surface of the overall arrangement to be exceeded. In this way, hairline cracks on the hob surface can be excluded. Basically, it can be said that the stiffness of the lower stabilizing plate must always be greater than that of the surface plate.

Now the special properties of carbon fibers or now also other fibers such as stone fibers or glass fibers and the special properties of suitable porous stone interact in an ideal manner in order to achieve the desired result of—macroscopically speaking—suppressing the overall expansion of the arrangement while at the same time suppressing the bulging of the stone surface.

In practice, a ratio of the thicknesses of the two stone slabs of 1:2 has proven to be on the safe side if the double-layered edge area is chosen to be wide enough in relation to the diameter of the cutout. A ratio of 2:3 of the stone thickness ratios lies within the limit and still on the safe side for most types of stone, if the edge areas stabilized by the lower stone slab are sufficiently wide in relation to the diameter of the cut in the cooking zone. A special case can be achieved if a stone with a higher porosity than the underside is used above the carbon layer, i.e. on the visible side of the overall arrangement. The stone on the underside with the lower porosity usually also has a higher rigidity and pressure resistance. In this case, a stone thickness ratio of 1:1 can also be sufficient to prevent hairline cracks if the edge areas are sufficiently wide in relation to the diameter of the cut in the cooking zone. Fine-crystalline gabbro rocks, for example, have proven to be sufficiently porous. They can be volume-compressed without crack formation and have the high pressure stability required for this application.

The cooking zones are additionally cooled from below in order to reduce the time-dependent temperature development. In addition, spacers between the pot and the hob surface can further reduce the temperature through air circulation based on natural convection. In addition, forced air routing above the cooktop surface can also remove warm air and thus provide additional cooling.

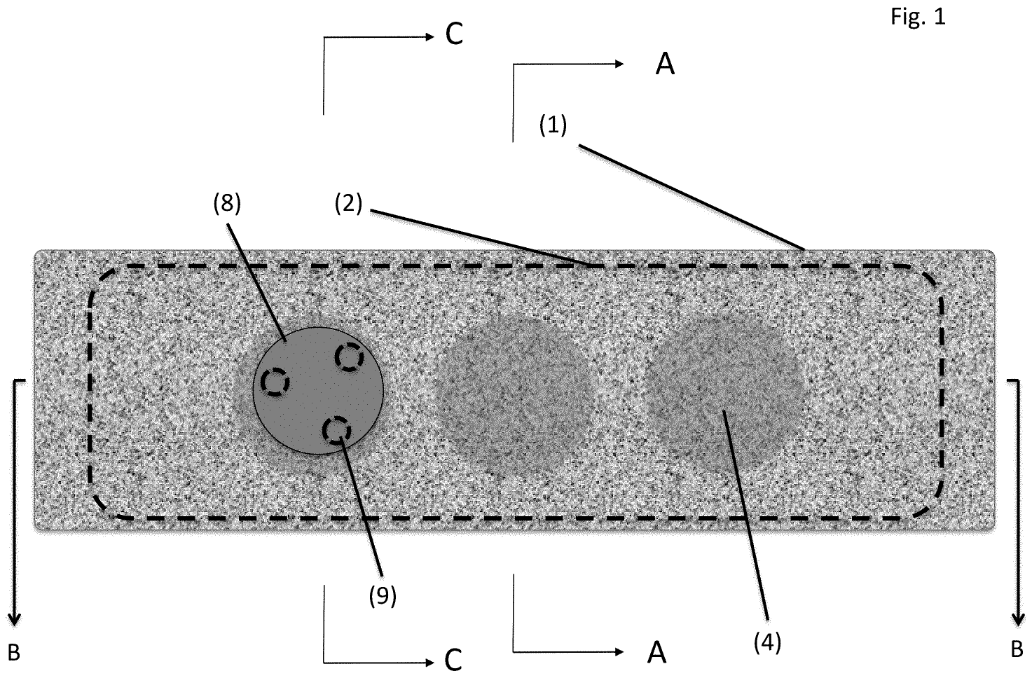

One of the many possible embodiments of the invention is shown in FIG. 1 with a stone plate (1) as the hob surface and a second stabilizing plate made of stone (2) with cutouts (4) underneath the plates, a pot (8) standing on the plate (1) with spacers (9) attached to the bottom of the pot.

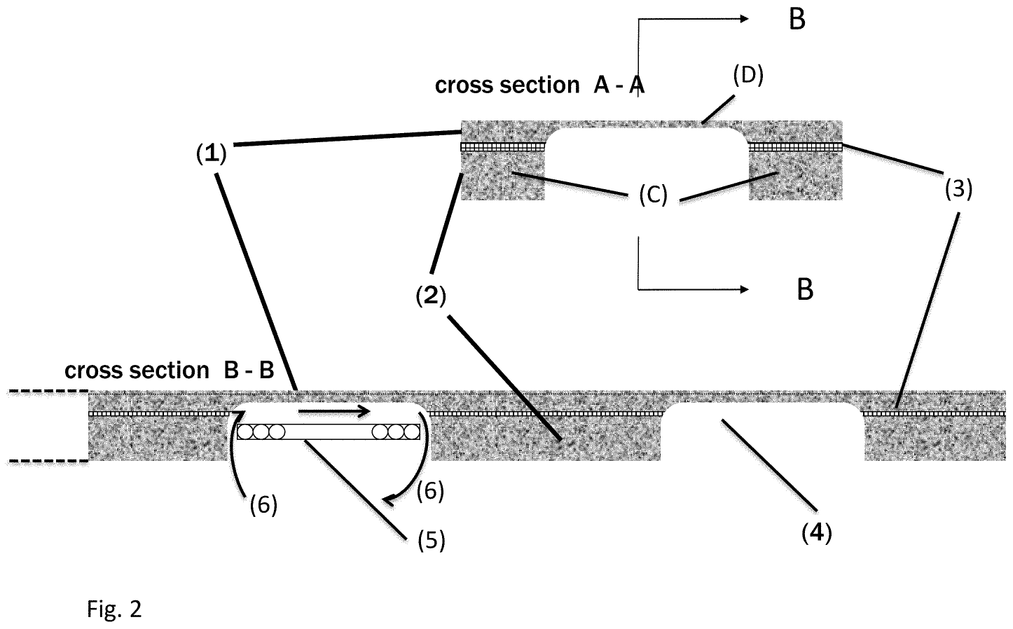

FIG. 2 shows the structure of FIG. 1 in cross section (A-A) with the carbon plates (3) mechanically connecting the two plates (1) and (2). Milled-out areas (4) house the induction coils (5), around which an air flow (6) flows in order to cool the stone of the plate (1) in the hob area from below. The thickness of the lower stone slab is significantly greater than that of the upper stone slab, in the form that the cross-section of the stone slab in the cooking zone is smaller than the cross-section of the lower stone slab in the edge areas between the cutout and the outer edge of the slab. For this purpose, the width of the edge area in relation to the diameter of the cut-out is dimensioned such that the counter-stabilizing minimum cross-section of the lower plate in the edge area (C) (viewed perpendicularly from the center of the cut-out on the long plate edge) is larger than the cross-section of the expanding stone mass in the area of the heating cooking zone (D).

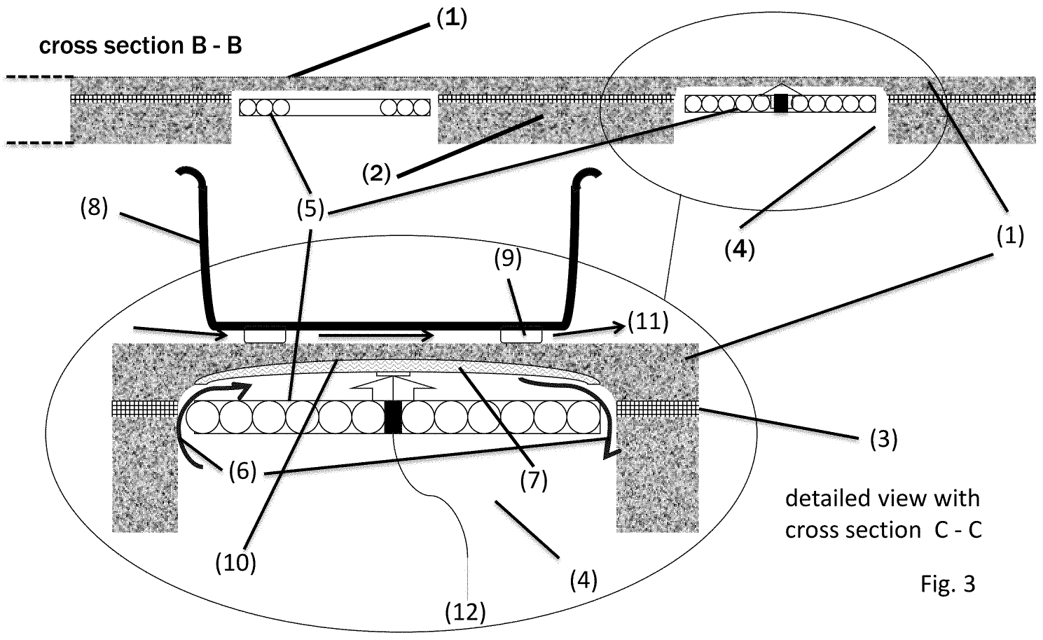

FIG. 3 shows the milling (4) with coil (5) in a detailed view with a stabilizing fiber layer (7) under the hob and a rotationally symmetrical concave underside of the stone slab (1).

In the area of the milling (4) above the plate (1), due to the of the rigid carbon layer is necessary.

### SUMMARY

The invention describes the asymmetrical structure of two or more stone plates—generally two—with respect to the layer structure, the load-bearing lower plate being designed stronger than the upper plate to be stabilized, which forms the surface of an induction cooking arrangement. The thickness or stiffness of the lower stone slab is designed in connection with an adequately dimensioned tensile fiber layer so that the tensile stresses in the upper slab due to the expansion of the upper slab when cooking—especially on the surface—due to the bimetal effect by bowl the plate—will not to be exceeded to avoid any hairline cracking. For this purpose, the cross-section and/or the rigidity of the lower plate in the counter-stabilizing edge areas must be designed so strongly that the expansion forces of the upper stone plate in the area of the cooking zone are sufficiently compensated by the pressure zone below the tension-resistant fiber layer, so that the maximum permissible tensile stress applied to the surface of the upper stone slab, which forms the hob, is not exceeded even when the maximum permitted cooking temperature is reached. In order to avoid deflection or curvature of the overall arrangement due to the bimetal effect, a sufficiently porous stone material is chosen on the surface, which is volume-compressible and/or preferably less pressure-resistant than the lower stabilizing plate, which builds up the counter pressure. To accommodate the induction coil, the plate arrangement is milled from below to just below the surface, so that the smallest possible distance between the induction coil and the pot is ensured. The cut-out is curved to increase the mechanical stability against pressure and impact from above. Additional fiber reinforcement can be attached here to help. Below and if necessary also above the stone surface circulating air is used in order to keep the surface temperatures on the hob and on the underside of the cooking zone as low as possible. Together, these measures serve the purpose of excluding the usual formation of hairline cracks on the surface of the overall arrangement.

distance between the pot (8) and the plate (1) through the spacers (9) below the pot, a natural convection flow (11) of the ambient air develops for the purpose of additional cooling the stone plate (1) in the cooktop area, the temperature of which in this area is measured, monitored and, if necessary, regulated with the aid of a temperature sensor (12) with a connecting cable connected to the induction electronics, and the induction can then be switched off if the temperature is, for example, due to an overheating pot, exceeding the limit values.

1) Arrangement with two or more layered slabs of natural stone, artificial stone such as concrete or resin-bonded stone powder, glass or ceramic—hereinafter referred to as stone slab or stone slabs—whereby the overall arrangement of the stone slabs is mechanically stabilized across the cross-section of the overall structure through stabilizing fiber fabric layers to prevent the plates from exceedance of the allowable tensile elongation, with a cutout under the surface of the upper stone layer which breaks through the stabilizing fiber layer and which extends itself right below the surface of the uppermost stone layer, with an induction coil sitting within the cavity for induction heating of magnetizable induction dishes,
characterized in that the rigidity of the stone geometry below the tensile-stable fiber layer is greater than the rigidity of the geometry of the upper cover layer, which forms the surface, whereby the fibers consist of carbon, glass or stone fibers.

2) Arrangement according to claim 1, characterized in that the ratio of the thickness of the stone layers in relation to the plate rigidity above and below the stabilizing carbon layer is designed so that the cross section of the temperature-expanding upper stone layer is so much smaller, than the minimum cross-section of the lower stone slab in the edge area between the cut and the stone slab edge, that the permissible tensile stress of the surface of the uppermost stone layer is not exceeded even if a surface temperature of 300° C. in the cooking zone is reached.

3) Arrangement according to claim 1 and 2, characterized in that the stone slab thickness above the tensile fiber layer is thinner than the stone slab thickness below the tensile fiber layer.

4) Arrangement according to claim 1 and 2, characterized in that the stone slab layer above the tensile fiber layer is a different material than the stone slab layer below the fiber layer.

5) Arrangement according to claim 1, 2, and 4, characterized in that the stone slab layer below the tensile fiber layer consists of a stiffer material than the stone slab layer above the fiber layer.

6) Arrangement according to claim 1 to 5, characterized in that the cavity of the milling is cooled by a circulating air stream in order to regulate and/or limit the maximum permitted temperature in the region of the cooking zone.

7) Arrangement according to claim 1 to 6, characterized in that the underside of the upper stone slab forms a concavely curved surface in the area of the milling, which ensures a natural mechanical stabilization against pressure from above onto the plate in the area of the milling against breakage or protect from breakthrough downwards.

8) Arrangement according to claim 1 to 7, characterized in that the underside of the milling is additionally stabilized against breakage due to impact in the cooking zone by a fiber matrix layer applied from below, which consists of either glass, stone or carbon fibers and a temperature-stable adhesive.

9) Arrangement according to claim 8, characterized in that the fiber-containing matrix of the fiber layer in the region of the cooking zone contains glass fibers, or stone fibers (basalt fibers) or a mixture of these different fiber materials and/or two layers of UD fabric carbon fibers in 0°/90° arrangement, wherein these two layers of UD carbon fabric are electrically insulated from one another by a layer of glass fibers or stone fibers or other fibers in order to exclude induced electric current flow in the carbon fabric.

10) Arrangement according to claim 1 to 9, characterized in that the surface of the upper stone slab is protected against the penetration of natural oils by a synthetic oil which is stable up to 300° C.

11) Arrangement according to claim 1 to 10, characterized in that the induction tableware used contains spacers which allow natural air convection between the stone surface and the pot material to additionally cool the upper stone slab on the surface, in order to avoid the burning in of natural and edible oils.

12) Arrangement according to claim 1 to 11, characterized in that the counter-stabilizing stone slab or the stone slabs below the top stabilizing carbon layer are made smaller in the horizontal XY coordinates, than the top stone slab.

13) Arrangement according to claim 1 to 12, characterized in that the coil shape is adapted to the curved shape of the milling and itself represents a curved plain.

14) Arrangement according to claim 1 to 13, characterized in that the coil in the middle carries a temperature sensor which measures the temperature at the bottom of the—if necessary. fiber-stabilized—measures the curvature of the underside of the upper stone slab and passes this measurement signal on to the induction control unit of the overall arrangement of the induction heating system, consisting of the induction control unit and induction coil, together with the necessary cable connection between the two, so that the induction control unit detects an exceeding of impermissibly high temperature to limit or switch off induction heating.

15) Arrangement according to claim 1 to 14, characterized in that the ratio of the thickness or rigidity of the stone slab or the stone slabs below the uppermost carbon layer in relation to the surface layer is so much larger that the deflection of the entire plate on the hob surface is de facto zero which is made possible by the fact that a stone structure with such a high pressure stiffness is used under the carbon layer that the bi-metal effect that usually occurs due to the compression of the stone material below the carbon layer is virtually zero, a correspondingly and sufficiently strong dimension
